(19) United States
(12) Patent Application Publication
(10) Pub. No.: US 2018/0302971 A1
(43) Pub. Date: Oct. 18, 2018

(54) METHOD OF LIGHTING DRIVER PROTECTION IN CASE OF LOSS OF NEUTRAL CONNECTION AND LIGHTING DRIVER INCLUDING SUCH PROTECTION

(71) Applicant: PHILIPS LIGHTING HOLDING B.V., EINDHOVEN (NL)

(72) Inventors: BERND CLAUBERG, SCHAUMBURG, IL (US); ALEJANDRO LOPEZ, LAKE ZURICH, IL (US); RAMAN NAIR HARISH GOPALA PILLAI, ARLINGTON HEIGHTS, IL (US)

(21) Appl. No.: 15/579,316

(22) PCT Filed: May 20, 2016
(86) PCT No.: PCT/EP2016/061478

§ 371 Date: Dec. 4, 2017

Related U.S. Application Data
(60) Provisional application No. 62/170,899, filed on Jun. 4, 2015.

(51) Int. Cl. H05B 33/08; H02M 1/32; H02M 1/42

(52) U.S. Cl. CPC H05B 33/0887; H02M 1/4208; H02M 1/32; H05B 33/0809

(57) ABSTRACT

A lighting driver (500) includes a controller (560) which controls the lighting driver to selectively operate in one of two different states, including a first state (850) wherein the output current is substantially constant regardless of the RMS value of an AC Mains in put voltage (15) applied across AC Mains connection terminals (502), and a second state (860) wherein the slope of the input impedance across the AC Mains connection terminals is maintained to be positive regardless of the AC Mains input voltage. The controller is configured to latch the lighting driver into the second state whenever the RMS value of the AC Mains voltage is less than a minimum RMS threshold voltage for a time period greater than a first threshold time period (T_{THRESHOLD}_{_}₁), or greater than a maximum RMS threshold voltage for a time period greater than a second threshold time period (T_{THRESHOLD}_{_}₂).

### TECHNICAL FIELD

The present invention is directed generally to lighting drivers for lighting units. More particularly, various inventive methods and apparatus disclosed herein relate to a method and system of protecting a lighting driver in the case that the neutral wire connection to the lighting driver is lost.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

One common installation for lighting units and associated lighting drivers, including LED lighting units and LED lighting drivers, employs a three-phase AC Mains power source. In these installations, the installer typically attempts to balance the loading of all the phases as much as possible to get optimal load sharing. Typically, three-phase wires and one neutral wire are run to fixtures connected to one circuit breaker, and then one of the three phases along with neutral is connected to each lighting driver, so that each lighting driver receives an AC mains voltage of one of the three phases. In particular, a common three-phase AC power source has a root mean square (RMS) voltage of 277 V between each phase and the neutral line, and 480 V between any two of the phases.

In such three-phase systems, it is possible to have the neutral wire disconnected accidentally (either during installation or after installation) in such a way that a lighting driver can be exposed to much higher than normal voltages, which can result in failure of the lighting driver and/or its associated lightings device.

### SUMMARY

The situation where the neutral wire is disconnected is illustrated by FIGS. 1 and 2. FIG. 1 illustrates an arrangement wherein first and second lighting drivers 100-1 and 100-2 are supplied power by two different phases of a three-phase AC power source in normal operation. Here, each of first and second lighting drivers 100-1 and 100-2 drive one or more lighting units, for example LED lighting units. In that case, first and second lighting drivers 100-1 and 100-2 may be referred to as LED lighting drivers.

In particular, the three-phase AC power source provides three AC voltages V_{PH1}, V_{PH2} and V_{PH3} between each of the three-phase wires and the neutral terminal 110. In an example installation, each of the RMS voltages of V_{PH1}, V_{PH2} and V_{PH3} is nominally 277 V (some power line variation is typical). V_{PH1} is supplied as an AC Mains voltage V1 between a line voltage terminal (Line) and a neutral terminal N of first lighting driver 100-1, and V_{PH2} is supplied as an AC Mains voltage V2 between a line voltage terminal (Line) and a neutral terminal N of second lighting driver 100-2. Thus in the example installation, each of first and second lighting drivers 100-1 and 100-2 receives a nominal AC Mains voltage of 277 V.

As described above, in some cases a break 112 occurs in the connection between neutral terminal 110, or neutral wire, of the three-phase AC power source and the neutral terminal of each of first and second lighting drivers 100-1 and 100-2.

FIG. 2 illustrates an arrangement wherein two lighting drivers are supplied power by a three-phase AC power source under a situation where the connection to neutral terminal 110 is lost. In this case, an RMS voltage of 480 V between two phases of the three-phase AC power source appears between the two line voltage terminals of first and second lighting drivers 100-1 and 100-2.

However, the individual voltages V1′ and V2′ applied between the line voltage terminal and the neutral terminal N of first and second lighting drivers 100-1 and 100-2, respectively, are indeterminate and in theory one of these individual voltages could be anywhere between 0 V and 480 V (V1′+V2′=480V).

Furthermore, in the particular example where first and second lighting drivers 100-1 and 100-2 are LED lighting drivers, then each lighting driver has an output stage which operates as a “constant current” source which supplies a constant (or substantially constant) current to the LED load throughout the operating input voltage range of the lighting driver. A similar situation would apply in the case of a fluorescent ballast or an electronically ballasted High Intensity Discharge (eHID) ballast in place of an LED lighting driver. An LED lighting driver typically includes a power factor conditioning circuit (PFC), and so its input sees a constant (or substantially constant) power load, as understood by those skilled in the art. Because the power supplied to the load is constant (or substantially constant), as the input voltage supplied to such a lighting driver increases within its operating voltage range, the input current decreases to maintain the constant (or substantially) constant power. That is to say, the slope of the input impedance of such an LED lighting driver is negative during normal operation, after start-up.

In the case when first and second lighting drivers 100-1 and 100-2 that drive LED loads are connected as shown in FIG. 3 with the neutral wire disconnected, this may result in an unstable operation and guarantee that the input voltages V1′ and V2′ will either oscillate, or move outside of the normal operation range to find a stable operating point. For example, where input voltages V1′ and V2′ add up to 480V, while at the same time the input currents supplied to first and second lighting drivers 100-1 and 100-2 remain equal to each other (since they are connected in series). In general, it may be expected that one of the input voltages V1′ or V2′ may be substantially greater than 277 V and the other may be substantially less, depending on slight differences in the input impedance characteristics between first and second lighting drivers 100-1 and 100-2. Typically, first and second lighting drivers 100-1 and 100-2 will not balance very well, and one of the lighting drivers 100-1 and 100-2 will observe nearly all of the 480V across its input terminals (i.e., between the line input terminal and neutral input terminal N), while the other one of the lighting drivers 100-1 and 100-2 will see very little voltage across its input terminals.

Such unexpected high voltages may damage the lighting driver, for example a surge protection device (SPD) of the lighting driver and/or a processor or controller of the lighting driver, and/or one or more lighting units driven by the lighting driver. As a result, the lighting driver may fail.

One option to overcome the problem of a failed lighting driver with loss of neutral is to design the driver (for example the SPD) to handle nearly the full 480V. In some fluorescent ballasts the design may include using a varistor (e.g., metal oxide varistor (MOV)) with a larger voltage threshold, and allowing for a short period of operation in the event of loss of neutral. However, such a varistor may give reduced surge protection to the ballast and is therefore not preferred, especially in the case of an outdoor LED driver where high surges may be common.

Thus, there is a need in the art for a method of protecting a lighting driver, and particularly a lighting driver which supplies a constant current to a lighting load, in the case of loss of the neutral connection to a three-phase AC power source, particularly when two drivers are connected to two difference phases of the three-phase AC power source. There is also a need for a lighting driver which employs such a method of protection in the event of loss of the neutral connection to a three-phase AC power source.

The present disclosure is directed to inventive methods and apparatus for protecting a lighting driver, and particularly a lighting driver which supplies a constant current to a lighting load, in the event of loss of the neutral connection to a three-phase power source.

Generally, in one aspect, a lighting driver comprises: a pair of AC Mains connection terminals configured to receive an AC Mains voltage, having a root-mean-square (RMS) value; a rectifier configured to rectify the AC Mains voltage and to output a rectified voltage; an output stage configured to supply an output current; a power factor correction stage connected between the rectifier and the output stage and configured to receive the rectified voltage and to supply power to the output stage; and a controller configured to control the output stage and to cause the lighting driver to selectively operate in one of two different states, including a first state wherein the output current is substantially constant regardless of the RMS value of the AC Mains voltage, and a second state wherein a slope of an input impedance across the AC Mains connection terminals is maintained to be positive regardless of the RMS value of the AC Mains voltage, wherein the controller is configured to latch the lighting driver into the second state whenever an RMS value of the AC Mains voltage is less than a minimum RMS threshold voltage for a time period greater than a first threshold time period and to latch the lighting driver into the second state whenever the RMS value of the AC Mains voltage is greater than a maximum RMS threshold voltage for a time period greater than a second threshold time period.

In some embodiments, the lighting driver further comprises a sensor configured to sense a voltage which has a defined relationship to the RMS value of the AC Mains voltage and to supply a signal to the controller indicating the sensed voltage.

In some versions of these embodiments the sensor senses the rectified voltage.

In some versions of these embodiments the sensor senses the AC Mains voltage.

In some versions of these embodiments the controller is configured to compare the sensed voltage to a first threshold value and to compare the sensed voltage to a second threshold value greater than the first threshold value, and is further configured to control the lighting driver to be latched into the second state whenever the sensed voltage is less than the first threshold value for a time period greater than the first threshold time period and to be latched into the second state whenever the sensed voltage is greater than the second threshold value for a time period greater than the second threshold time period.

In some embodiments, the controller is configured to turn off the power factor correction stage and the output stage whenever the lighting driver is latched in the second state.

In some embodiments, the controller is configured to control the output stage to cause the output current to increase in proportion to an increase in the RMS value of the AC Mains voltage whenever the lighting driver is latched in the second state.

In some embodiments, the lighting unit further comprises a DALI transceiver configured to communicate messages between the lighting driver and an external DALI controller which is external to the lighting driver, and further configured such that when the RMS value of the AC Mains voltage is greater than the maximum RMS threshold voltage for a time period greater than the second threshold time period, the lighting driver communicates an overvoltage message via the DALI transceiver to the external DALI controller.

In some embodiments, the first threshold time period is the same as the second threshold time period.

In another aspect, a method of operating a lighting driver which is configured to drive a lighting unit including at least one light source, comprises: receiving, at AC Mains connection terminals of the lighting driver, an AC Mains voltage with a root-mean-square (RMS) value; rectifying the AC Mains voltage via a rectifier of the lighting driver to output rectified AC Mains power having a rectified voltage; selectively operating the lighting driver in one of two states. The two states include: a first state wherein the lighting driver supplies the lighting unit with an output current which is substantially constant regardless of the RMS value of the AC Mains voltage, and a second state wherein a slope of an input impedance of the lighting driver across the AC Mains connection terminals is maintained to be positive regardless of the RMS value of the AC Mains voltage. The lighting driver is latched into the second state whenever an RMS value of the AC Mains voltage is less than a minimum RMS threshold voltage for a time period greater than a first threshold time period, and is further latched into the second state whenever the RMS value of the AC Mains voltage is greater than a maximum RMS threshold voltage for a time period greater than a second threshold time period.

In some embodiments, the method further comprises: sensing a voltage which has a defined relationship to the RMS value of the AC Mains voltage; comparing the sensed voltage to a first threshold value and to a second threshold value greater than the first threshold value; whenever the sensed voltage is less than the first threshold value for a time period greater than the first threshold time period, latching the lighting driver into the second state; and whenever the sensed voltage is less than the second threshold value for a time period greater than the second threshold time period, latching the lighting driver into the second state.

In some embodiments, the method further comprises turning off a power factor correction stage and an output stage of the lighting driver whenever the lighting driver is latched into the second state.

In some embodiments, the method further comprises controlling the output current to cause it to increase in proportion to an increase in the RMS value of the AC Mains voltage whenever the lighting driver is latched in the second state.

In some embodiments, the method further comprises communicating an overvoltage message to an external DALI controller when the RMS value of the AC Mains voltage is greater than the maximum RMS threshold voltage for a time period greater than the second threshold time period

In yet another aspect, an apparatus comprises: a first lighting driver and a second lighting driver, each of the first and second lighting drivers having a corresponding pair of AC Mains connection terminals, including a line voltage terminal and a neutral terminal; wherein the line terminal of the first lighting driver is connected to a first phase voltage line of a three-phase AC Mains power supply, and the line voltage terminal of the second lighting driver is connected to a second phase voltage line of the three-phase AC Mains power supply, wherein the neutral terminals of the first and second lighting drivers are connected together to each other; wherein each of the first and second lighting drivers further includes an output stage which is configured to output a substantially constant current to a corresponding lighting unit when the neutral terminals of the first and second lighting drivers are connected to a neutral line of the three-phase AC Mains power supply, and wherein each of the first and second lighting drivers is configured to provide an input impedance across the corresponding pair of AC Mains connection terminals which has a positive slope regardless of a voltage level of a voltage across the corresponding pair of AC Mains connection terminals when one or both of the neutral terminals of the first and second lighting drivers are disconnected from the neutral line of the three-phase AC Mains power supply.

In some embodiments, the first lighting driver includes a sensor configured to detect when the neutral terminal of the first lighting driver is disconnected from the neutral line of the three-phase AC Mains power supply.

In some versions of these embodiments, the second lighting driver includes a sensor configured to detect when the neutral terminal of the second lighting driver is disconnected from the neutral line of the three-phase AC Mains power supply.

In some embodiments, the first lighting driver further includes a controller configured to turn off the output stage when the neutral terminal of the first lighting driver is disconnected from the neutral line of the three-phase AC Mains power supply.

In some embodiments, the second lighting driver further includes a controller configured to turn off the output stage when the neutral terminal of the second lighting driver is disconnected from the neutral line of the three-phase AC Mains power supply.

In some embodiments, the first lighting driver further includes a controller configured to control the output stage to cause the output current to increase in proportion to an increase in the RMS value of the voltage across the corresponding pair of AC Mains connection terminals when the neutral terminal of the first lighting driver is disconnected from the neutral line of the three-phase AC Mains power supply

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED light sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED lighting unit” refers to a lighting unit that includes one or more LED light sources as discussed above, alone or in combination with other non LED light sources.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, EEPROM and FLASH memory, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an arrangement wherein two lighting drivers are supplied power by two different phases of a three-phase AC power source in normal operation.

FIG. 2 illustrates an arrangement wherein two lighting drivers are supplied power by a three-phase AC power source when the connection to the neutral terminal is lost.

FIG. 3 illustrates the input current and the output current as a function of the input voltage level for an example light emitting diode (LED) lighting driver during normal operation.

FIG. 4 illustrates the input current as a function of the input voltage level for one embodiment of an LED lighting driver in a second (standby) state.

FIG. 5 illustrates an example embodiment of a lighting driver.

FIG. 6 illustrates a first example embodiment of a loss of neutral detector.

FIG. 7 illustrates a second example embodiment of a loss of neutral detector.

FIG. 8 a flowchart of an example embodiment of a method 800 of operating a lighting driver, including protecting the lighting driver in the case of loss of the neutral connection.

### DETAILED DESCRIPTION

When a pair of LED lighting drivers is connected to two phases of a three-phase AC power source and the neutral wire is disconnected, this will typically result in an unstable operation where the input voltage to each LED lighting driver is indeterminate. This can lead to an overvoltage condition which can damage the LED lighting driver and lead to failure.

More generally, the inventor has recognized and appreciated that it would be beneficial to enable LED lighting drivers to sense or detect loss of neutral conditions and to adjust the input impedance such that the input voltage to the LED driver system is within nominal range to avoid damage to the LED lighting driver and/or the lighting unit(s) which it drives.

In view of the foregoing, various embodiments and implementations of the present invention are directed to inventive methods and apparatuses for detecting the phase-cut angle of a phase-cut dimming signal. For example, methods and apparatuses are provided for digitally detecting the phase-cut angle of a phase-cut dimming signal so that a signal can be generated for dimming the light output of the LED light sources by the appropriate amount.

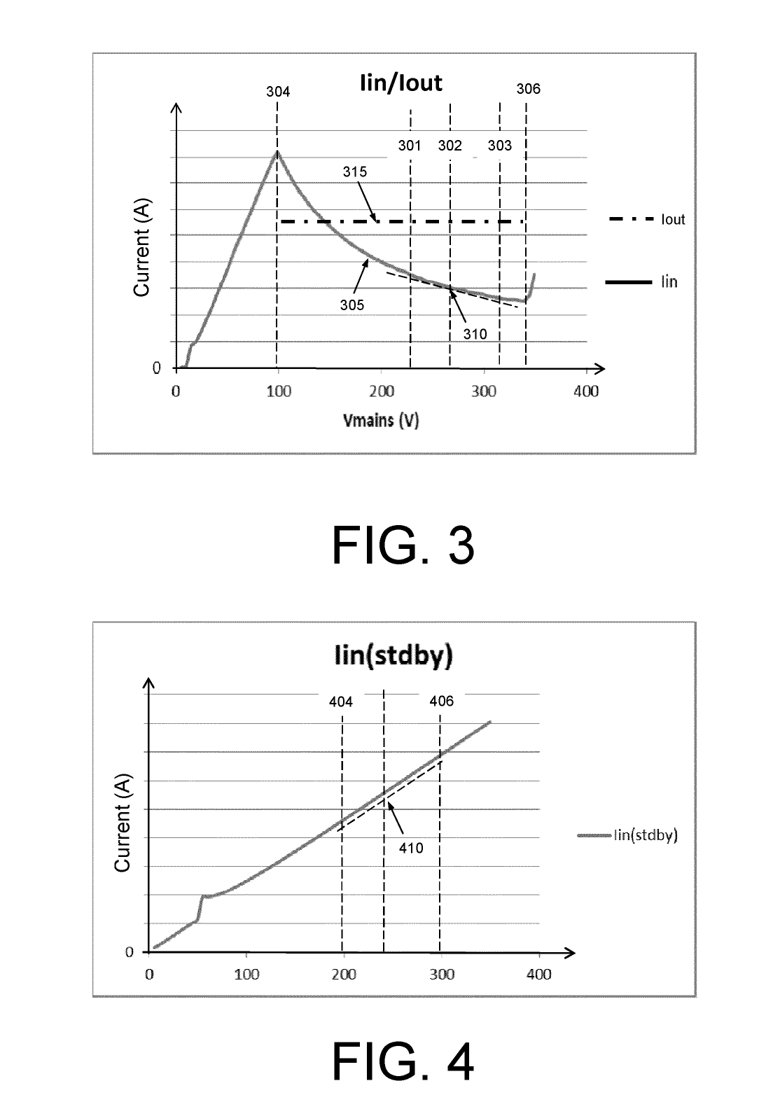

FIG. 3 illustrates the input current (lin) and the output current (Iout) as a function of the RMS input voltage level (Vmains) for an example light emitting diode (LED) lighting driver during normal operation. Here for convenience of explanation it is assumed that the input voltage Vmains is expressed as an RMS voltage, but the same current versus voltage characteristics apply whether the input voltage is expressed as a peak voltage level or average voltage level, as the input voltage waveform for AC Mains is known to be a sinusoidal waveform. In FIG. 3, the input current (lin) as a function of the input voltage level (Vmains) is illustrated by the plot 305, and the output current (Iout) as a function of the input voltage level (Vmains) is illustrated by the plot 315.

The normal operating range of the example LED lighting driver whose characteristics are illustrated in FIG. 3 are defined by a lower normal-operation voltage threshold 304 and an upper normal-operation voltage threshold 306. When the input voltage Vmains is less than lower input voltage threshold 304, the input current lin typically decreases with decreasing input voltage Vmains due to either an under voltage lockout in the LED lighting driver, or a current limit on the power factor correction (PFC) stage of the LED lighting driver. Because the LED lighting driver cannot maintain maximum power at very low input voltages due to limitations and losses in the PFC stage, normal operation is typically locked out with these input voltage levels, to avoid overheating.

During start-up of the LED lighting driver, the input voltage Vmains may be outside this range, particularly less than lower normal-operation voltage threshold 304, as the voltage comes up to its nominal value. But during normal operation, the input voltage Vmains is expected to remain between lower normal-operation voltage threshold 304 and upper normal-operation voltage threshold 306. In some embodiments, Vmains is nominally 277 V, although of course some variation is expected.

As shown in FIG. 3, within the normal, operating, range, as the input voltage Vmains increases, the current Iln decreases, as shown by the declining slope line 310. That is to say, the slope or derivate of the input impedance of the LED lighting driver is negative. This can be expressed using derivatives as:

dVmains/dlin<0 (1)

As explained above, when a pair of LED lighting drivers is connected to two phases of a three-phase AC power source and the neutral wire is disconnected, this will typically result in an unstable operation where the input voltage to each LED lighting driver is indeterminate. This can lead to an overvoltage condition which can damage the LED lighting driver and lead to system failure.

To address this problem, an LED lighting driver may be configured to detect the loss of neutral condition. As a result of the detection, the lighting driver may switch from a “first (normal operating) state” to a “second (standby) state” where the slope of the input impedance of the driver is maintained to be positive, such that the input voltage can more evenly balance between the two LED lighting drivers within their operating ranges. In some embodiments, once the LED lighting driver is switched to the second (standby) state the LED lighting driver remains latched in that state until the LED lighting driver is reset, for example by cycling power to the LED lighting driver after reconnecting the neutral terminal of the three-phase AC power source to the LED lighting driver.

FIG. 4 illustrates the input current lin as a function of the RMS input voltage level Vmains for one embodiment of an LED lighting driver in a second (standby) state. Here it is seen by the slope line 410 that in this second (standby) state, the slope or derivative of the input impedance as a function of input voltage is maintained to be positive at least across an input voltage range between a lower standby voltage threshold 404 and an upper standby voltage threshold 406. In some embodiments, the input impedance of the LED lighting driver in the second (standby) state is constant or substantially constant, and the slope or derivative of the input impedance is constant or substantially constant.

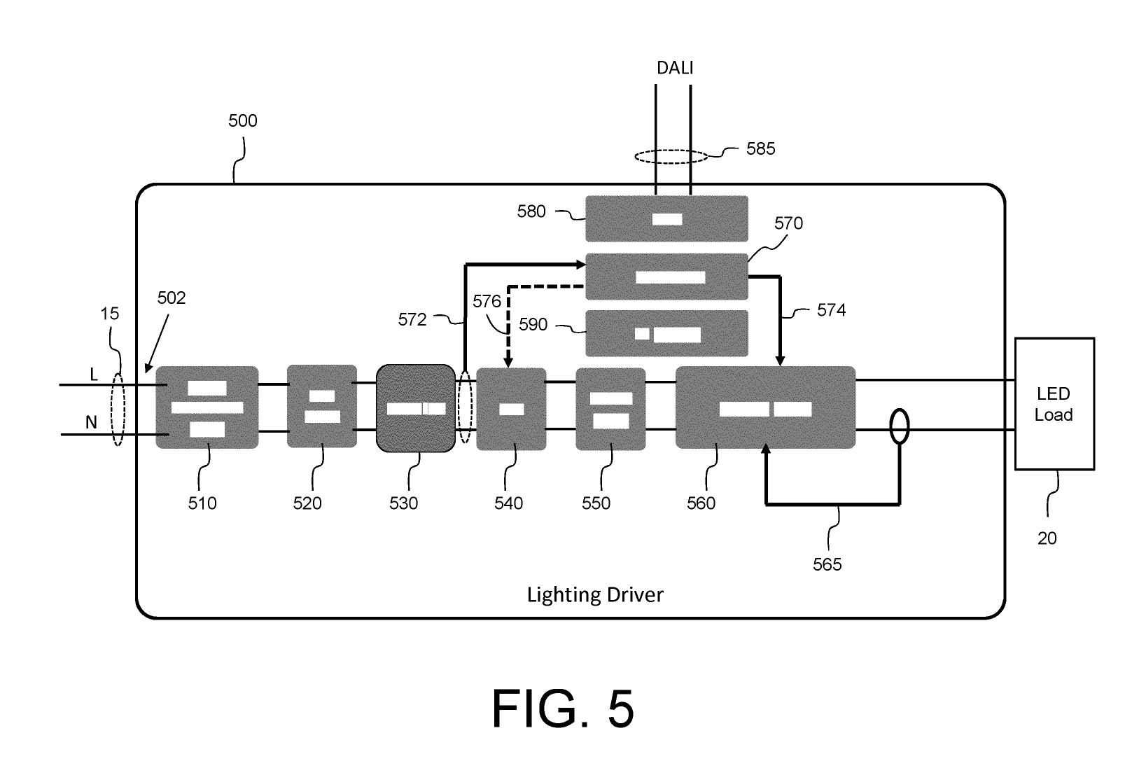

FIG. 5 illustrates an example embodiment of an LED lighting driver 500. In particular, LED lighting driver 500 is one example of an LED lighting driver configured to detect the loss of neutral condition, and switch from a “first (normal operating) state” to a “second (standby) state” where the slope of the input impedance of the driver is maintained to be positive in the second (standby) state. In some embodiments, once LED lighting driver 500 is switched to the second (standby) state it remains latched in that state until LED lighting driver 500 is reset, for example by cycling power to LED lighting driver 500 after reconnecting the neutral line.

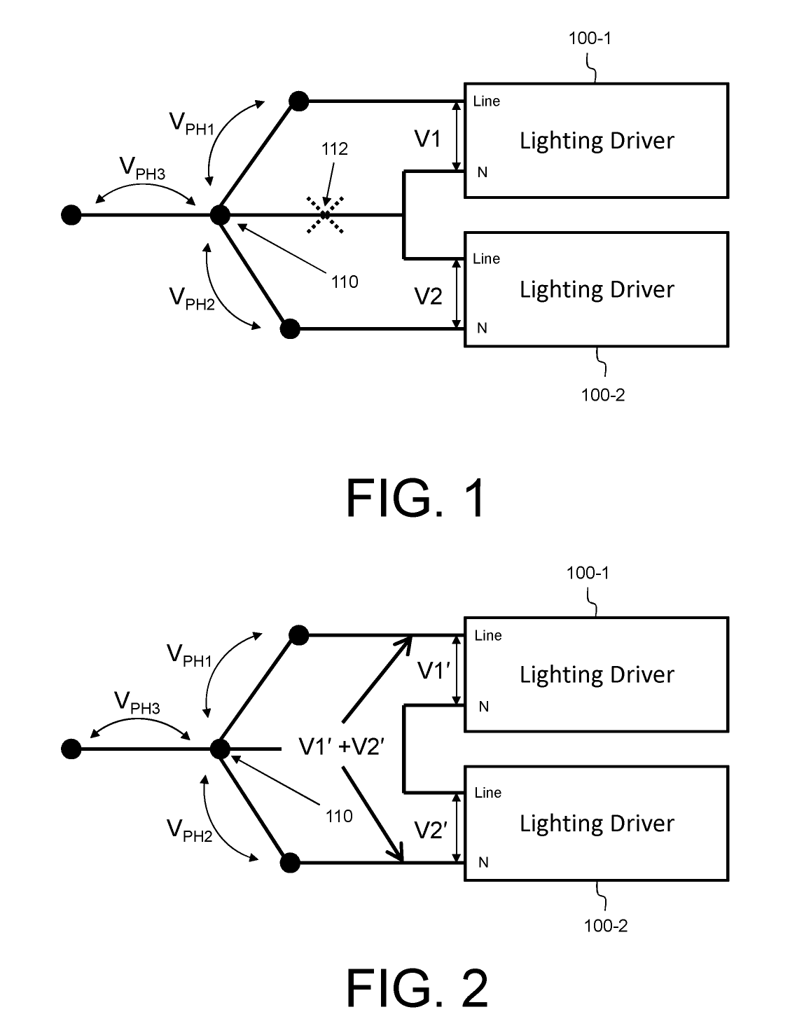

According to an embodiment, LED lighting driver 500 has a pair of AC Mains connection terminals 502, including a line voltage terminal and a neutral terminal, for receiving an AC Mains voltage, similarly to lighting drivers 100-1 and 100-2 of FIG. 1. LED lighting driver 500 also includes a surge protection circuit (SPC) 510, an electromagnetic interference (EMI) filter 520, a rectifier 530, a power factor correction circuit (PFC) stage 540, a buffer capacitor 550, an output stage 560, a controller 570 (which may include a microprocessor), a digital lighting interface (DALI) transceiver 580, and a low voltage (LV) supply 590.

LED driver 500 drives a lighting unit comprising an LED load 10, which may include one or more LED light sources, by supplying an output current 565. DALI transceiver 580 may be connected to a DALI network (not shown) via line pair 585 such that LED lighting driver 500 may exchange DALI messages with one or more other DALI devices (e.g., a DALI controller) of the DALI network. Controller 570 is connected to receive from a sensor (e.g., a sampling resistor not shown in FIG. 5) a sensed or detected voltage 572 at the output of rectifier 530, and is further connected to provide a control signal 574 to control operations of output stage 560, which in turn senses output current 565. Controller 570 also optionally provides a control signal 576 for turning on and off PFC stage 540, as discussed below. In some embodiments, control signal 576 may be omitted.

It should be understood that LED lighting driver 500 represents one general embodiment of a LED lighting driver which is configured to detect the loss of neutral condition, and then switch from a “first (normal operating) state” to a “second (standby) state” where the slope of the input impedance of the driver is maintained to be positive in the second (standby) state. In other embodiments, one or more of the elements shown in FIG. 5, such as SPC 510, EMI filter 520 and/or DALI transceiver 580, may be omitted. The construction and operation of SPC 510, EMI filter 520, rectifier 530, PFC stage 540, buffer capacitor 550, output stage 560, and low voltage (LV) supply 590 are generally known and will not be described in detail here for brevity.

In operation, LED lighting driver receives an AC Mains voltage 15 at AC Mains connection terminals 502 and supplies power to LED load 10. More specifically, AC Mains connection terminals 502 receive an AC Mains voltage 15, rectifier 530 rectifies AC Mains voltage 15 and output a rectified voltage 572; PFC stage 540, which is connected between the rectifier and the output stage, receives rectified voltage 572 and supplies power to output stage 560; and output stage supplies output current 565 to LED load 10. Controller 570 controls output stage 560, and can cause LED lighting driver 500 to selectively be in one of two different states, including a first (normal operation) state wherein output current 565 is substantially constant regardless of the RMS value of AC Mains voltage 15, and a second (standby) state wherein a slope of an input impedance across AC Mains connection terminals 502 is maintained to be positive regardless of the RMS value of AC Mains voltage 15.

LED lighting driver 500 may detect loss of the neutral connection to AC Mains connection terminals 502 as follows. Lighting driver 500 (e.g., controller 570) senses a voltage (here, e.g., rectified voltage 572 output by rectifier 530) which is proportional to the RMS, average, peak, or peak-to-peak value of the AC Mains voltage 15 which is supplied to LED lighting driver 500, and compares the sensed voltage to a minimum threshold voltage and a maximum threshold voltage. In other embodiments, other voltages which are proportional to the RMS, average, peak, or peak-to-peak value of the AC Mains voltage 15 may be sensed. For example, in some embodiments AC Mains voltage 15 may be sensed or detected directly across AC Mains connection terminals 502 and filtered to produce a signal representing its RMS, average, peak value, peak-to-peak value, etc.

The discussion to follow will focus on the RMS value of the AC Mains voltage 15. However, where AC Mains voltage 15 is a sinusoidal waveform, as is typically the case, then it is understood that a well-known and defined relationship exists between the RMS, average, peak value, and peak-to-peak values. Accordingly, it is assumed that any one of these values may be determined from any other of these values. Furthermore, when it is said that an RMS value of the AC Mains voltage is less than a minimum RMS threshold voltage or greater than a maximum RMS threshold voltage, it is understood that this is equivalent to the peak value of the AC Mains voltage being less than a minimum peak threshold voltage or greater than a maximum peak threshold voltage, and the peak-to-peak value of the AC Mains voltage being less than a minimum peak-to-peak threshold voltage or greater than a maximum peak-to-peak threshold voltage, etc.

So long as the sensed or detected voltage is less than the minimum threshold voltage for a time period greater than a first threshold time period, or greater than the maximum threshold voltage for a time period greater than a second threshold time period, LED lighting driver 500 continues to be in a first state where normal operation occurs, and output stage 560 will function as a constant current source for supplying a constant (or substantially constant) output current 565 to LED load 10. FIG. 3 shows an example plot 315 of output current (Iout) 565 as a function of the input voltage level (Vmains) 15. It is understood that in practice a perfectly constant current supply to LED load 10 may not be achieved, and thus we describe the current as substantially constant. By “substantially constant” we mean that the variation in output current 565 in the first state, during normal operation, is no more than +/−10%. In some beneficial embodiments, output current 565 may be maintained constant within even tighter tolerances, for example +/−5%, +/−2%, or +/−1%.

When the sensed or detected voltage is less than the minimum threshold voltage for a time period greater than a first threshold time period, or greater than the maximum threshold voltage for a time period greater than a second threshold time period, LED lighting driver 500 determines that a loss of neutral connection condition has occurred.

In response to detecting that a loss of neutral connection condition has occurred, LED lighting driver 500 can take corrective action. In particular, LED lighting driver 500 switches to a second (standby) state wherein the derivative of slope of the input impedance of LED lighting driver 500 across AC Mains connection terminals 502 is maintained to be positive regardless of the RMS value of AC Mains voltage 15. In some embodiments, controller 570 causes LED lighting driver 500 to switch to the second (standby) state by turning off PFC stage 540 and output stage 580. In some embodiments, controller 570 causes LED lighting driver 500 to switch to the second (standby) state by controlling output stage 560 to cause output current 565 supplied to LED load 10 to increase in proportion to an increase in the RMS value of AC Mains voltage 15. Beneficially, once LED lighting driver 500 enters the second state in response to detection of loss of the neutral connection, it may remain in the second state until LED lighting driver 500 is reset, for example by cycling power to LED lighting driver 500 after reconnecting the neutral terminal of the three-phase AC power source to LED lighting driver 500.

In some embodiments, in response to detecting that a loss of neutral connection condition has occurred, LED lighting driver 500 may cause DALI transceiver 580 to communicate an overvoltage message to the external DALI controller via the DALI network.

As described above, controller 570 may include a loss of neutral detector to detect the loss of the neutral connection whenever the RMS value (or peak value, or average value) of AC Mains voltage 15 is less than a minimum RMS threshold voltage for a time period greater than a first threshold time period, or the RMS value of AC Mains voltage 15 is greater than a maximum RMS threshold voltage for a time period greater than a second threshold time period.

In some embodiments the minimum and maximum RMS threshold voltages may be preset into LED lighting driver 500 as fixed values. In other embodiments, they may be selected in response to one or more DALI messages received from an external DALI controller by DALI transceiver 580. In some embodiments, the minimum RMS threshold voltage may be set at a value within a range that is 10% to 20% less than the nominal RMS AC Mains voltage, for example, and the maximum RMS threshold voltage may be set at a value within a range of 10% to 20% more than the nominal RMS AC Mains voltage. For example where the nominal AC Mains voltage is 120-277 V RMS, the minimum threshold voltage may be set at 100 V RMS, and the maximum threshold may be set at 320 V RMS. It should be understood that these are example values, and different values may be selected for optimizing performance of the loss of neutral detection in different installations.

In some embodiments, the first and second threshold time periods may be selected to be greater than time periods associated with startup and setting times for AC Mains voltage 15 when LED lighting driver 500 is first turned on. In some embodiments, first and second threshold time periods may be on the second of several milliseconds. In general first and second threshold time periods may be different than each other, but in some embodiments first and second threshold time periods may be the same as each other.

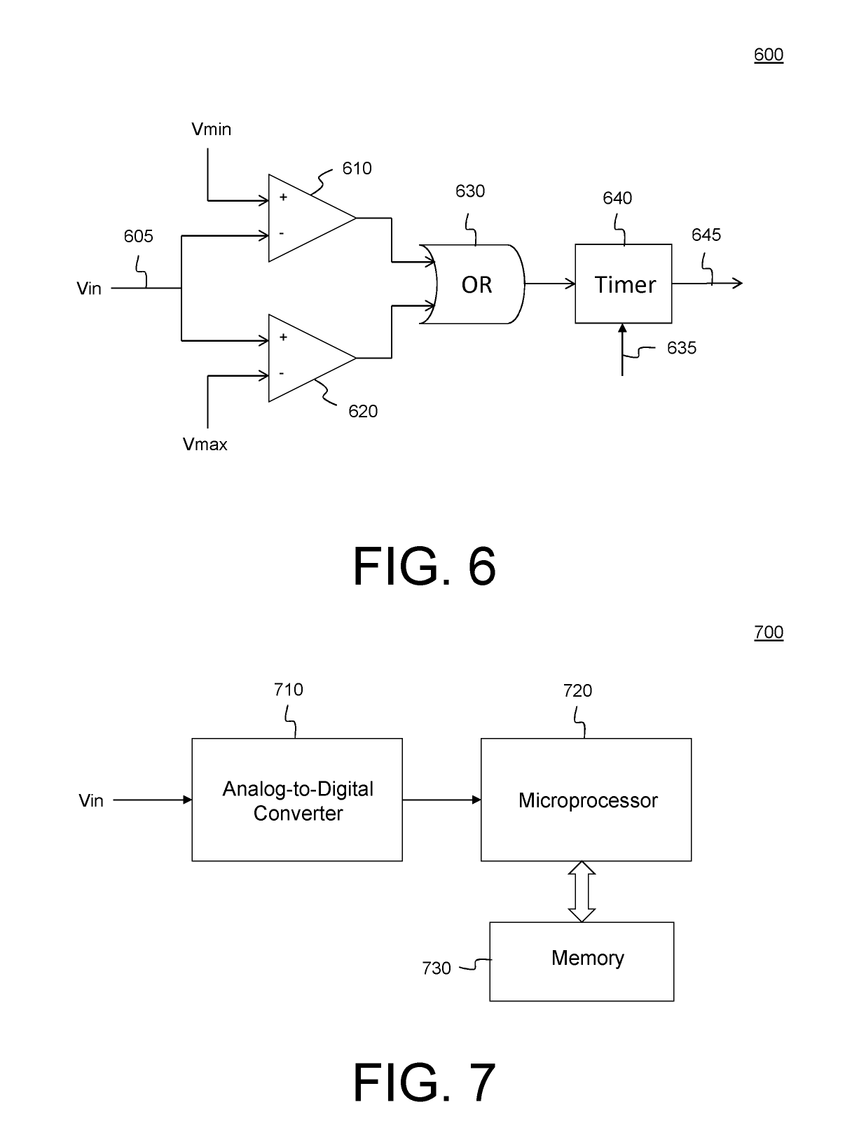

FIG. 6 illustrates a first example embodiment of a loss of neutral detector 600 which may be included in controller 570. Loss of neutral detector 600 is an example of an analog detector which compares a sensed voltage 605 (Vin) to analog minimum and maximum threshold voltages, Vmin and Vmax, respectively. Vin may be filtered prior to being supplied to loss of neutral detector 600 so that it is essentially a DC value within one or a few cycles of AC Mains voltage 15. In some embodiments, Vin may be produced by sampling rectified voltage 572.

Meanwhile, Vmin and Vmax may be selected to correspond to the minimum and maximum threshold RMS (or peak or peak-to-peak, etc.) voltages of AC Mains 15 for loss of neutral detection by scaling them with a proportionality constant which is the same as the proportionality factor between AC Mains 15 and Vin, as would be understood by those skilled in the art.

Loss of neutral detector 600 includes comparators 610 and 620, logic (OR gate) 630, and a timer 540 which is programmed with a threshold time value 635. In operation Vin is compared to Vmin and Vmax. As long as Vin is >Vmin and <Vmax, then both outputs of comparators 610 and 620 are low, the output of logic 630 is low, timer 640 is not triggered, and the output signal 645 remains low, indicating that loss of neutral has not been detected. Here, output signal 645 may be provided to an input of a microprocessor (not shown) of controller 570 which controls operations of LED lighting driver 500. In response to output signal 645 indicating that loss of neutral has not been detected, the microprocessor may control LED lighting driver 500 to remain in the first (normal operation) state, as described above.

If Vin becomes >Vmin or <Vmax, then a corresponding one of the outputs of comparators 610 and 620 becomes high, the output of logic 630 becomes high, and timer 640 is triggered. At this time, the output signal 645 remains low, indicating that loss of neutral has not (yet) been detected. If the timer remains triggered for a time period longer than threshold time value 635 (in this embodiment, the first and second threshold time periods for loss of neutral detection are the same as each other), then output signal 645 goes high, indicating that loss of neutral has been detected. In response to output signal 645 indicating that loss of neutral has been detected, the microprocessor may control LED lighting driver 500 to change or transition to the second (standby) state, as described above. Output signal 645 may be latched high by a latch (not shown in FIG. 6), or the microprocessor which receives output signal 645 may internally latch itself into the second state.

FIG. 7 illustrates a second example embodiment of a loss of neutral detector 700. Loss of neutral detector 700 includes an analog-to-digital converter (ADC) 710, a microprocessor 720, and a memory 730. Microprocessor 720 may be the same microprocessor in controller 570 which controls operations of the LED lighting driver 500, such as operations of output stage 560, DALI transceiver 580 and/or PFC stage 540. Loss of neutral detector 700 is an example of a digital detector which compares a digitized value, output by ADC 710, representing a sensed voltage 705 (Vin) to minimum and maximum threshold values (for example stored in memory 730).

It should be understood that FIGS. 6 and 7 are two of numerous configurations of loss of neutral detectors which may be included in LED lighting driver 500.

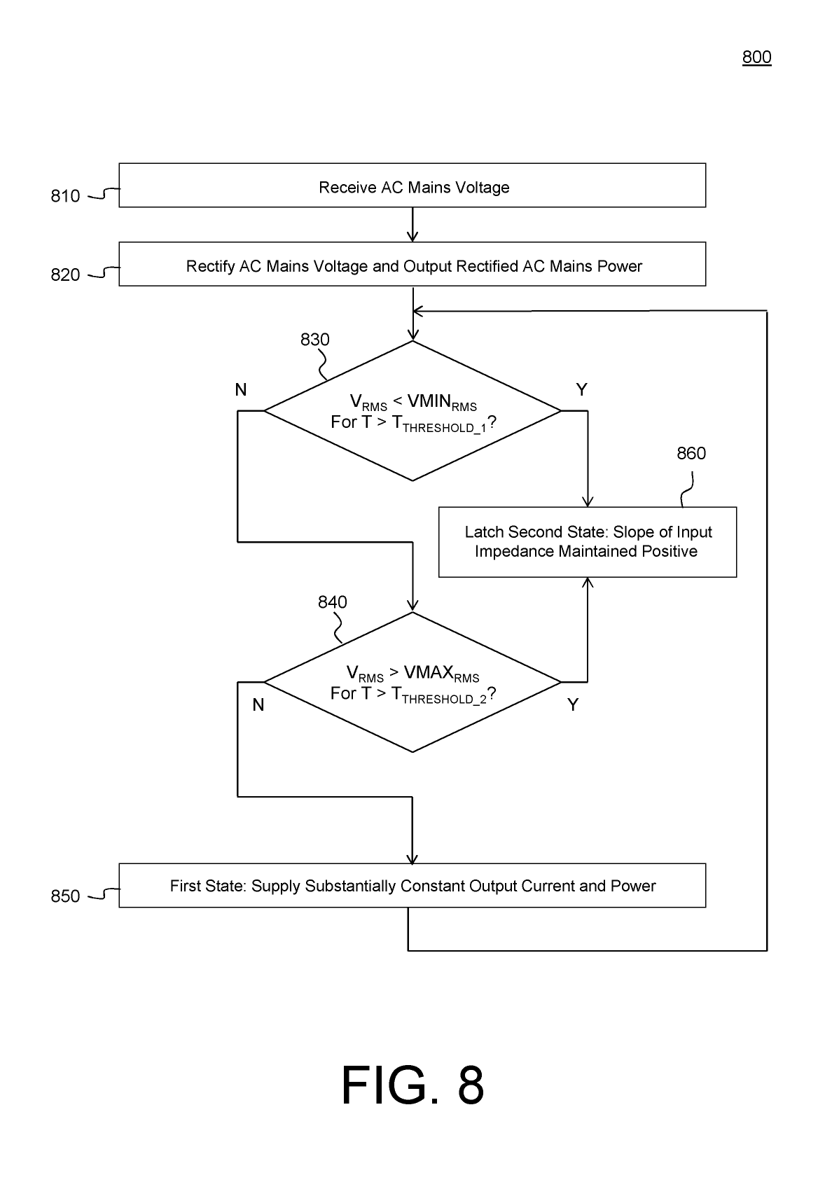

FIG. 8 illustrates a flowchart of an example embodiment of a method 800 of operating a lighting driver (e.g., LED lighting driver 500), including protecting the lighting driver in the case of loss of the neutral connection to the lighting driver.

In an operation 810, AC Mains connection terminals of the lighting driver receive an AC Mains voltage.

In an operation 820, a rectifier of the lighting driver rectifies the AC Mains voltage and outputs rectified AC Mains power.

In operation 830, it is determined whether the RMS value of the received AC Mains voltage (V_{RMS}) has been less than a predefined minimum RMS threshold voltage (VMIN_{RMS}) for a time period greater than a first threshold time period T_{THRESHOLD}_{_}₁. If not, then the process proceeds to operation 840. Here it should be understood that since the AC Mains voltage is a defined sinusoidal waveform, the RMS value of the received AC Mains voltage (V_{RMS}) has a well-known and defined relationship to other values such as the peak value of the received AC Mains voltage (V_{PEAK}), the average value of the received AC Mains voltage (V_{AVG}), and the peak-to-peak value of the received AC Mains voltage (V_{PEAK-TO-PEAK}). Accordingly, it is understood that determining whether the RMS value of the received AC Mains voltage (V_{RMS}) is less than the defined minimum threshold voltage (VMIN) may be accomplished in some embodiments by determining whether the peak value of the received AC Mains voltage (V_{PEAK}) is less than a corresponding minimum peak threshold voltage (VMIN_{PEAK}), or by determining whether the peak-to-peak value of the received AC Mains voltage (V_{PEAK-TO-PEAK}) is less than a corresponding minimum peak-to-peak threshold voltage (V_{MINPEAK-TO-PEAK}), or by determining whether the average value of the received AC Mains voltage (V_{AVG}) is less than a corresponding minimum average threshold voltage (VMIN_{AVG}), etc.

In an operation 840, it is determined whether the RMS value of the received AC Mains voltage (V_{RMS}) has been greater than a predefined maximum RMS threshold voltage (VMAX_{RMS}) for a time period greater than a second threshold time period T_{THRESHOLD}_{_}₂. If not, then the process proceeds to operation 850. Here it should be understood that since the AC Mains voltage is a defined sinusoidal waveform, determining whether the RMS value of the received AC Mains voltage (V_{RMS}) is greater than the predefined maximum RMS threshold voltage (VMAX_{RMS}) may be accomplished in some embodiments by determining whether the peak value of the received AC Mains voltage (V_{PEAK}) is greater than a corresponding maximum peak threshold voltage (VMAX_{PEAK}), or by determining whether the peak-to-peak value of the received AC Mains voltage (V_{PEAK-To-PEAK}) is greater than a corresponding maximum peak-to-peak threshold voltage (VMAX_{PEAK-To-PEAK}), or by determining whether the average value of the received AC Mains voltage (V_{AVG}) is greater than a corresponding maximum average threshold voltage (VMAX_{AVG}) etc.

In an operation 850, the lighting driver is in a first (normal operation) state wherein it supplies a substantially constant output current and power to a lighting unit (e.g., a lighting unit comprising an LED load). In the first state, operations 830 and 840 are repeatedly or continuously performed.

Operations 830 and 840 may be viewed as a single operation of detecting a loss of a neutral connection to the lighting driver, wherein when the loss of neutral is not detected, then the lighting driver remains in a first (normal operation) state in operation 850.

However, when it is determined in operation 830 that the RMS value of the received AC Mains voltage has been less than the predefined minimum RMS threshold voltage for a time period greater than a first threshold time period, or in operation 840 that the RMS value of the received AC Mains voltage has been greater than the predefined maximum RMS threshold voltage for a time period greater than the second threshold time period, then in an operation 860, the lighting driver is latched into a second (standby) state. In the second (standby) state, the slope of the input impedance of the lighting driver across the AC Mains connection terminals is maintained to be positive regardless of the RMS value of the AC Mains voltage.

It should be understood by one skilled in the art that many of the operations illustrated in FIG. 8 are continuous operations which may and do actually occur in parallel with each other. For example the AC Mains connection terminals may continuously receive the AC Mains voltage while the rectifier continuously rectifies the received AC Mains voltage and outputs rectified AC Mains power, etc.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lighting driver, comprising:
a pair of AC Mains connection terminals configured to receive an AC Mains voltage having a root-mean-square (RMS) value;
a rectifier, configured to rectify the AC Mains voltage and to output a rectified voltage;
an output stage configured to supply an output current;
a power factor correction stage connected between the rectifier and the output stage and configured to receive the rectified voltage and to supply power to the output stage; and
a controller configured to control the output stage and to cause the lighting driver to selectively be in one of two different states, including a first state wherein the output current is substantially constant regardless of the RMS value of the AC Mains voltage, and a second state wherein a slope of an input impedance across the AC Mains connection terminals is maintained to be positive regardless of the RMS value of the AC Mains voltage, wherein the controller is configured to latch the lighting driver into the second state whenever an RMS value of the AC Mains voltage is less than a minimum RMS threshold voltage for a time period greater than a first threshold time period and to latch the lighting driver into the second state whenever the RMS value of the AC Mains voltage is greater than a maximum RMS threshold voltage for a time period greater than a second threshold time period.

2. The lighting driver of claim 1, further comprising a sensor configured to sense a voltage which has a defined relationship to the RMS value of the AC Mains voltage and to supply a signal to the controller indicating the sensed voltage.

3. The lighting driver of claim 2, wherein the sensor senses the rectified voltage.

4. The lighting driver of claim 2, wherein the sensor senses the AC Mains voltage.

5. The lighting driver of claim 2, wherein the controller is configured to compare the sensed voltage to a first threshold value and to compare the sensed voltage to a second threshold value greater than the first threshold value, and is further configured to control the lighting driver to be latched into the second state whenever the sensed voltage is less than the first threshold value for a time period greater than the first threshold time period and to be latched into the second state whenever the sensed voltage is greater than the second threshold value for a time period greater than the second threshold time period.

6. The lighting driver of claim 1, wherein the controller is configured to turn off the power factor correction stage and the output stage whenever the lighting driver is latched in the second state.

7. The lighting driver of claim 1, wherein the controller is configured to control the output stage to cause the output current to increase in proportion to an increase in the RMS value of the AC Mains voltage whenever the lighting driver is latched in the second state.

8. The lighting driver of claim 1, further comprising a DALI transceiver configured to communicate messages between the lighting driver and an external DALI controller which is external to the lighting driver, and further configured such that when the RMS value of the AC Mains voltage is greater than the maximum RMS threshold voltage for a time period greater than the second threshold time period, the lighting driver communicates an overvoltage message via the DALI transceiver to the external DALI controller.

9. The lighting driver (500) of claim 1, wherein the first threshold time period is the same as the second threshold time period.

10. A method of operating a lighting driver which is configured to drive a lighting unit including at least one light source, the method comprising:
receiving, at AC Mains connection terminals of the lighting driver, an AC Mains voltage with a root-mean-square value;
rectifying the AC Mains voltage via a rectifier of the lighting driver to output rectified AC Mains power having a rectified voltage;
selectively operating the lighting driver in one of two states, including:
a first state wherein the lighting driver supplies the lighting unit with an output current which is substantially constant regardless of the RMS value of the AC Mains voltage, and
a second state wherein a slope of an input impedance of the lighting driver across the AC Mains connection terminals is maintained to be positive regardless of the RMS value of the AC Mains voltage,
wherein the lighting driver is latched into the second state whenever an RMS value of the AC Mains voltage is less than a minimum RMS threshold voltage for a time period greater than a first threshold time period, and is further latched into the second state whenever the RMS value of the AC Mains voltage is greater than a maximum RMS threshold voltage for a time period greater than a second threshold time period.

11. The method of claim 10, further comprising:
sensing a voltage which is proportional to the RMS value of the AC Mains voltage;
comparing the sensed voltage to a first threshold value and to a second threshold value greater than the first threshold value;
whenever the sensed voltage is less than the first threshold value for a time period greater than the first threshold time period, latching the lighting driver into the second state; and
whenever the sensed voltage is less than the second threshold value for a time period greater than the second threshold time period, latching the lighting driver into the second state.

12. The method of claim 10, further comprising turning off a power factor correction stage and an output stage of the lighting driver whenever the lighting driver is latched into the second state.

13. The method of claim 10, further comprising controlling the output current to cause it to increase in proportion to an increase in the RMS value of the AC Mains voltage whenever the lighting driver is latched in the second state.

14. The method of claim 10, further comprising communicating an overvoltage message to an external DALI controller when the RMS value of the AC Mains voltage is greater than the maximum RMS threshold voltage for a time period greater than the second threshold time period.
